(19) United States
(12) Patent Application Publication
(10) Pub. No.: US 2009/0316388 A1
(43) Pub. Date: Dec. 24, 2009

(54) BACKLIGHT MODULE

(75) Inventor: Jen-Tsorng Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/347,274

(22) Filed: Dec. 31, 2008

(30) Foreign Application Priority Data
Jun. 18, 2008 (CN) 200810302184.1

(51) Int. Cl. G09F 13/08

(52) U.S. Cl. 362/97.1

(57) ABSTRACT

A backlight module includes first and second light guide plates and first and second LEDs. The first and second light guide plates each has a top surface, a bottom surface opposite to the top surface, and a light incident surface interconnecting the top surface and the bottom surface. The bottom surfaces of the first and second light guide plates contact each other. The top surface of the first light guide plate is defined as a reflective surface and the top surface of the second light guide plate is defined as a light emitting surface. The first LED is positioned adjacent to the light incident surface of the first light guide plate and the second LED configured for emitting light of different colors.

### BACKGROUND

1. Field of the Disclosure

The present disclosure relates to backlighting, and particularly, to a backlight module applying light emitting diodes (LEDs).

2. Description of Related Art

Liquid crystal display devices have many excellent performance characteristics, such as large-scale information display ability, easy colorization, low power consumption, long life, no pollution associated therewith, and so on. Therefore, liquid crystal display devices are widely used. A typical liquid crystal display device generally includes a backlight module. The backlight module is used to convert linear light sources or point light sources, such as cold cathode ray tubes or LEDs, into area light sources with high uniformity and brightness.

In a backlight module using LEDs as light sources, the LED typically emits monochromatic light or white light. The monochromatic light and the white light have low color saturation, and may not satisfy user requirements.

What is needed, therefore, is a backlight module using LEDs with high color saturation.

### BRIEF DESCRIPTION OF THE DRAWINGS

Many aspects of the present backlight module can be better understood with reference to the following drawings. The components in the drawings are not necessarily drawn to scale, the emphasis instead being placed upon clearly illustrating the principles of the present backlight module. Moreover, in the drawings, like reference numerals designate corresponding parts throughout the several views.

FIG. 1 is a schematic, isometric view of a backlight module in accordance with a first embodiment.

FIG. 2 is a schematic, isometric view of a backlight module in accordance with a second embodiment.

FIG. 3 is a schematic, isometric view of a backlight module in accordance with a third embodiment.

### DETAILED DESCRIPTION OF THE EMBODIMENTS

Reference will now be made to the drawings to describe embodiments of the present backlight module, in detail.

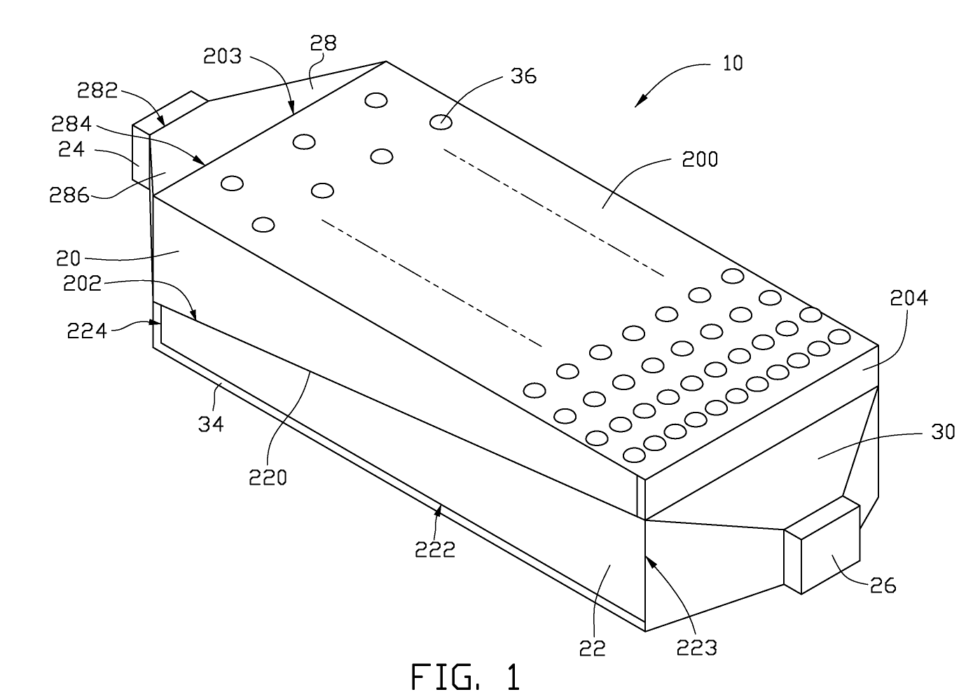

Referring to FIG. 1, a backlight module 10 in accordance with a first exemplary embodiment is provided. The backlight module 10 includes a first light guide plate 20, a second light guide plate 22, a first LED 24 and a second LED 26. The first and second light guide plates 20 and 22 are wedge-shaped.

The first light guide plate 20 has a light emitting surface 200, a first bottom surface 202 opposite to the light emitting surface 200, a first light incident surface 203 interconnecting the light emitting surface 200 and the first bottom surface 202, and a first side face 204 opposite to the first light incident surface 203. The light emitting surface 200 is substantially perpendicular to the first light incident surface 203. The first bottom surface 202 is inclined to the first light incident surface 203. The first light incident surface 203 has a larger area than the first side face 204.

The second light guide plate 22 has a light reflective surface 222, a second bottom surface 220 opposite to the light reflective surface 222, a second light incident surface 223 interconnecting the light reflective surface 222 and the second bottom surface 220, and a second side face 224 opposite to the second light incident surface 223. The light reflective surface 222 is substantially perpendicular to the second light incident surface 223. The second bottom surface 220 is inclined to the second light incident surface 223. The second light incident surface 223 has larger area than the second side face 224.

The first light guide plate 20 and the second light guide plate 22 are assembled together in a manner such that the first bottom surface 202 of the first light guide plate 20 contacts the second bottom surface 220, and the first light incident surface 203 is opposite to the second light incident surface 223. The first side face 204, the second side face 224 and the reflective surface 222 each have a reflective film 34 coated thereon.

The backlight module 10 further includes a first light collection member 28 and a second light collection member 30. The first light collection member 28 is positioned on the first light incident surface 203 and the second light collection member 30 is positioned on the second light incident surface 223. The first light collection member 28 may be truncated pyramid or truncated conical shaped. In this embodiment, the first light collection member 28 is rectangular pyramid shaped. The first light collection member 28 has a top surface 282, a bottom surface 284 opposite to the top surface 282, and four side faces 286 with a reflective film (not labeled) coated thereon. The bottom surface 284 of the first light collection member 28 has an area larger than the top surface 282. The bottom surface 284 of the first light collection member 28 is identically shaped to the first light incident surface 203 and contacts the first light incident surface 203. The first LED 24 contacts the top surface 282 of the light collection member 28. The first light collection member 28 may be a light-pervious epoxy resin. The light collection member 28 reflects light emitted from the first LED 24 to the first light guide plate 20.

The second light collection member 30 has a structure identical to the first light collection member 28. A cooperative relation between the second light collection member 30 and the second light guide plate 22 is identical to a cooperative relation between the first light collection member 28 and the first light guide plate 20. A cooperative relation between the second light collection member 30 and the second LED 26 is identical with a cooperative relation between the first light collection member 28 and the first LED 24.

The first light guide plate 20 and the second light guide plate 22 cooperatively form a light guide module (not labeled). The light emitting surface 200 acts as a light emitting surface of the light guide module and the light reflecting surface 222 acts as a bottom surface of the light guide module. The light reflecting surface 222 reflects light emitted from first and second LEDs 24 and 26 towards the light emitting surface 200 such that the light emerges from the light emitting surface 200. The backlight module 10 further includes a plurality of micro-structures 36 formed on or defined in the light emitting surface 200. The micro-structures 36 may be hemispherical or pyramid-shaped protrusions or recesses, or prisms or grooves being V-shaped or semi-cylindrical. Distribution density of the micro-structures 36 increases with distance away from the first light incident surface 203 towards the first side face 204. The micro-structures 36 improve luminance and uniformity of light emitted from the light emitting surface 200.

Preferably, the light emitting surface 200 has a length along an orientation perpendicular to the first light incident surface 203 from 20 centimeters (cm) to 50 cm. The light emitted from the light emitting surface 200 with this length provides not only high brightness, but also enhanced uniformity.

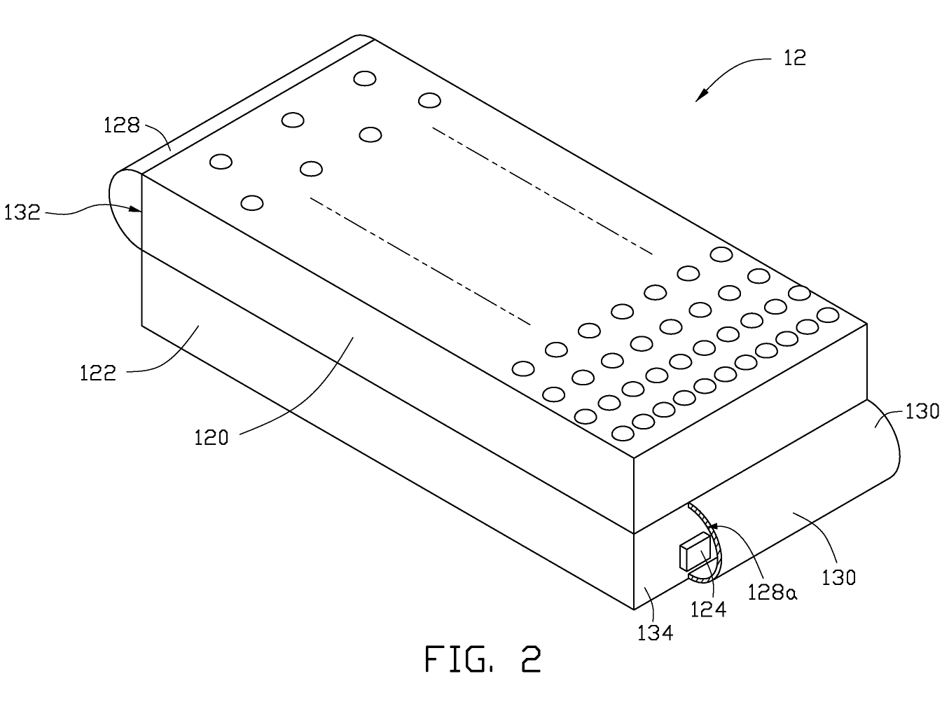

Referring to FIG. 2, a backlight module 12 is provided in accordance with a second exemplary embodiment, differing from the previous embodiment only in that a first light guide plate 120 and a second light guide plate 122 of the backlight module 12 are flat light-guide plates, a first reflecting cover 128 is included to replace the first light collection member 28, and a second reflecting cover 130 is included to replace the second light collection member 30. The first reflecting cover 128 is positioned facing a first light incident surface 132 of the first light guide plate 120 and the second reflecting cover 130 is positioned facing the second light incident surface 134. A first LED array (not labeled) is positioned between the first light incident surface 132 and the first reflecting cover 128. A second LED array 124 is positioned between the second light incident surface 134 and the second reflecting cover 130. The first LED array and the second LED array 124 are both arrayed in a line. The first reflecting cover 128 reflects the light emitted from the first LED array into the first light guide plate 120, and the second reflecting cover 130 reflects the light emitted from the second LED array 124 into the second light guide plate 122.

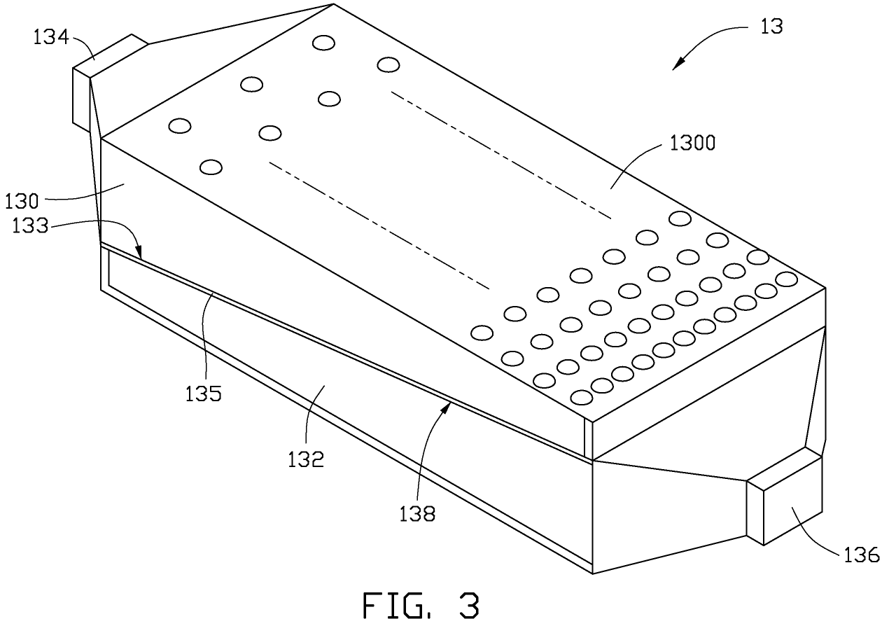

Referring to FIG. 3, a backlight module 13 is provided in accordance with a third exemplary embodiment, differing from the first exemplary embodiment only in that the backlight module 13 further includes a selective light permeation layer 135 sandwiched between a first bottom surface 133 of a first light guide plate 130 and a second bottom surface 138 of the second light guide plate 132.

The selective light permeation layer 135 reflects light emitted from a first LED 134 to the light emitting surface 1300 and transmitting light emitted from a second LED 136 to the light emitting surface 1300. In this exemplary embodiment, the light emitted from the first LED 134 has a different wavelength from the light emitted from the second LED 136, and the selective light permeation layer 135 has a characteristic of reflecting the light emitted from the first LED 134 and permitting the light emitted from second LED 136 to be transmitted therethrough. For example, color of the light emitted from the first LED may be green and light from the second LED red, demonstrating light blocking and reflecting capabilities of selective light permeation layer 135.

It is to be understood that the first LED and the second LED in the first exemplary embodiment and the third exemplary embodiment each can be an LED array comprising a plurality of LEDs arrayed in a line. In addition, the selective light permeation layer 135 can also be applied to the backlight module 12 of the second exemplary embodiment, i.e. sandwiched between the first light guide plate 120 and the second guide plate 122.

The backlight modules in the embodiments disclosed apply two or more LEDs with different colors, with light emitted therefrom being hybrid white light or hybrid color light, increasing the color saturation of the backlight module.

It is believed that the embodiments and their advantages will be understood from the foregoing description and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A backlight module, comprising:
first and second light guide plates each comprising a top surface, a bottom surface opposite to the top surface, and a light incident surface interconnecting the top surface and the bottom surface, the bottom surfaces of the first and second light guide plates contacting each other, the top surface of the first light guide plate being a reflective surface and the top surface of the second light guide plate being a light emitting surface;
a first LED adjacent to the light incident surface of the first light guide plate and
a second LED positioned adjacent to the light incident surface of the second light guide plate, the first LED and the second LED being configured for emitting light of different colors.

2. The backlight module as claimed in claim 1, further comprising a selective light permeation layer sandwiched between the bottom surfaces of the light guide plates, configured for blocking and reflecting the light emitted from the first LED and transmitting the light emitted from the second LED therethrough.

3. The backlight module as claimed in claim 1, wherein the first and the second light guide plates are wedge-shaped plates, the bottom surfaces of the first and second light guide plates being inclined to the light incident surface and the top surfaces of the first and second light guide plates being perpendicular to the light incident surface, the light incident surfaces of the first and second light guide plates being opposite to each other.

4. The backlight module as claimed in claim 1, wherein the first and second light guide plates are flat light guide plates.

5. The backlight module as claimed in claim 1, further comprising a first light collection member between the first LED and the light incident surface of the first light guide plate and a second light collection member between the second LED and the light incident surface of the second light guide plate, the first light collection member being configured for reflecting the light emitted from the first LED into the first light guide plate, the second light collection member being configured for reflecting the light emitted from the second LED into the second light guide plate.

6. The backlight module as claimed in claim 5, wherein the first light collection member has a truncated pyramid shape or a truncated cone shape, the first light collection member having a first top surface, a first bottom surface opposite to the first top surface and a first side face interconnecting the first top surface and the first bottom surface, the first bottom surface being larger than the first top surface and contacting the light incident surface of the first light guide plate, and the first LED facing the first top surface, which is coated with a light reflective material.

7. The backlight module as claimed in claim 6, wherein the second light collection member has a truncated pyramid or truncated cone shape, the first light collection member has a second top surface, a second bottom surface opposite to the second top surface and a second side face interconnecting with the second top surface and the second bottom surface, the second bottom surface being larger than the second top surface and contacting the light incident surface of the second light guide plate, the second LED facing the second top surface, the second side face being coated with a light reflective material.

8. The backlight module as claimed in claim 1, wherein the first and second light guide plates each have a side surface opposite to the light incident surface, and a reflecting material coating the side surfaces and the bottom surface of the second light guide plate.

9. The backlight module as claimed in claim 1, further comprising a plurality of micro-structures formed on or a plurality of recesses defined in the top surface of the first light guide plate.

10. The backlight module as claimed in claim 9, wherein the micro-structures, protrusions, or recesses are hemispherical or pyramid-shaped.

11. The backlight module as claimed in claim 9, wherein distribution density of the micro-structures increases with distance from the first light incident surface.
